(19) United States
(12) Patent Application Publication
(10) Pub. No.: US 2021/0348000 A1
(43) Pub. Date: Nov. 11, 2021

(54) ZINC-RICH WATERBORNE EPOXY COATING COMPOSITION AND METHODS

(71) Applicant: Tnemec Company, Inc., North Kansas City, MO (US)

(72) Inventors: Katherine M. Carder, Overland Park, KS (US); Jeremy M. Ethington, Cameron, MO (US); Remi Briand, Leawood, KS (US)

(21) Appl. No.: 17/156,063

(22) Filed: Jan. 22, 2021

Related U.S. Application Data
(60) Provisional application No. 62/964,491, filed on Jan. 22, 2020.

(51) Int. Cl. C09D 5/10; C08G 59/50; C08G 59/24; C09D 163/04; C09D 7/61; C08K 3/22; C08K 3/08; C23C 26/00

(52) U.S. Cl. CPC C09D 5/106; C08G 59/50; C08G 59/245; C09D 163/04; C09D 7/61; C08K 2201/014; C08K 3/08; C23C 26/00; C08G 2150/90; C08K 2003/2265; C08K 2003/0893; C08K 3/22

(57) ABSTRACT

A composition for use in coating surfaces and a method for coating surfaces with the composition is disclosed. The composition comprises a first component including a waterborne amine curing agent, a second component including an epoxy resin, and a third component including zinc dust. The first component, the second component, and the third component being combinable to provide a zinc-rich waterborne epoxy coating, wherein the coating composition provides an anti-corrosion protection to a metal substrate.

### CROSS REFERENCE TO RELATED APPLICATIONS

This application claims priority from U.S. Provisional application No. 62/964,491, filed Jan. 22, 2020, titled ZINC-RICH WATERBORNE EPOXY COATING COMPOSITION AND METHODS, which is hereby incorporated by reference in its entirety.

### TECHNICAL FIELD

Embodiments of the present disclosure relate generally to anti-corrosive coating compositions, and more particularly to zinc-rich waterborne epoxy coating compositions and methods relating to such compositions.

### BACKGROUND

Zinc-rich coatings are applied to the surface of a metal substrate to protect the metal substrate from corrosion. The zinc interacts with the metal substrate in an electrochemical reaction in which the zinc serves as an electron donor to provide cathodic protection of the metal substrate. To provide a suitable level of cathodic protection however zinc-rich coatings require high levels of zinc particles to achieve the necessary interaction. Because zinc is an expensive material to add to epoxy coatings, a need exists for a coating that requires less zinc to provide a similar or greater protection of a metal substrate.

### BRIEF DESCRIPTION OF THE DRAWINGS

The drawings constitute a part of this specification and include exemplary embodiments of the disclosed subject matter and illustrate various objects and features thereof.

FIG. 1 is a scanning electron micrograph of the microporous structure of the waterborne system compared with a standard cycloaliphatic amine at 20,000 times magnification.

### DETAILED DESCRIPTION

Unless specifically noted, it is intended that the words and phrases herein be given their plain, ordinary, and accustomed meaning to those of ordinary skill in the applicable arts. In the following description, and for the purposes of explanation, numerous specific details are set forth in order to provide a thorough understanding of the various aspects of the invention. It will be understood, however, by those skilled in the relevant arts, that embodiments of the present invention may be practiced without these specific details. In other instances, known structures and devices are shown and/or discussed more generally in order to avoid obscuring the invention. In many cases, a description of the operation is sufficient to enable one of ordinary skill in the applicable art to implement the various forms of the invention. It should be appreciated that there are many different and alternative configurations, devices and technologies to which the disclosed inventions may be applied. The full scope of the present disclosure is not limited to the examples described below.

The present disclosure provides a zinc-rich waterborne epoxy coating composition useful to provide anti-corrosion protection to metal substrates. The zinc-rich waterborne epoxy coating composition may be prepared as a mixture of two pre-blended components or of three pre-blended components. A first component includes a waterborne amine curing agent. A second component includes an epoxy resin. A third component includes zinc dust. The first component may also include one or more of a thixatrope, a defoamer, a pigment, an extender, and a flash rust inhibitor. The second component may also include a diluent. The third component may also include micaceous iron oxide. When combined, the first, second, and third components produce a zinc-rich waterborne epoxy coating that is applied to the surface of a metal substrate to protect the metal substrate from corrosion.

As described in further detail below, the zinc-rich waterborne epoxy coating composition comprises a waterborne amine curing agent that forms a micro-porous polymer structure within the cured epoxy film. The micro-porosity of the polymer structure improves the interaction among the zinc particles in the dry film, which increases the conductivity of the particles within the coating, increases the cathodic performance of the zinc particles, and increases the overall corrosion protection of the metal substrate. By increasing the contact between zinc particles, the zinc-rich waterborne epoxy composition provides for the use of a lower level of zinc to accomplish the same cathodic protection compared with an equivalent solvent-based organic zinc-rich coating.

The waterborne amine curing agent may be a water-dilutable polyamine having a plurality of N-H linkages capable of reacting with the epoxy resin to create a micro-porous polymer structure in the cured film. Waterborne amine curing agents that form a porous structure are used when applying an epoxy coating to a concrete substrate. The micro-pores formed by the amine curing agents provide breathability and moisture permeability to the epoxy coating, which prevents blistering, cracking, or separation that may occur when an epoxy coating is applied to a concrete substrate. In one embodiment, the waterborne amine curing agent of the coating composition is selected from commercially-available waterborne amine curing agents formulated for use in an epoxy coating applied to a concrete substrate.

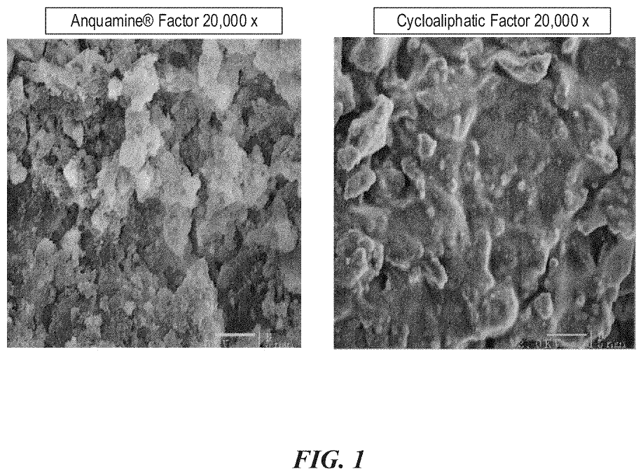

FIG. 1 illustrates a scanning electron micrograph of the microporous structure of the waterborne system (using EVONIK ANQUAMINE 701) compared with a standard cycloaliphatic amine at 20,000 times magnification.

The waterborne amine curing agent may comprise one or more of the following, cycloaliphatic amine, aromatic amine, polyether amine, polyamide, aminoamide, adduct or Mannich-based terminated amine, tertiary amine, and the like. According to some embodiments, the waterborne amine curing agent of the composition comprises for example, EVONIK ANQUAMINE 701, ALLNEX, BECKOPDX EH 623, ALLNEX BECKOPDX EH2162, HEXION EPIKURE 8530-W-75, HEXION EPIKURE 8535-W-50, JEFFAMINE T403, and other like waterborne amine-curing agents.

The epoxy resin may be liquid, solid or semi-solid, or a dispersion in solvent or water comprising, for example, one or more of bisphenol A, bisphenol F, epoxy phenol Novolac, epoxy cresol, and the like. According to embodiments, the epoxy resin comprises EVONIK ANCAREZ AR555, EVONIK ANCAREZ AR 462, and other like epoxy resins.

The composition may comprise a diluent to decrease the viscosity or increase the solubility of the epoxy resin. The diluent may be either reactive or non-reactive. In one embodiment, the diluent is a non-reactive diluent that does not react with the other constituents of the composition. In one embodiment, the non-reactive diluent may be included in another component of the composition. According to embodiments, the non-reactive diluent is one or more of EVONIK EPODIL LV5, cardanol, benzyl alcohol, nonyl-phenol, tert-butyl-phenol, alkylated aromatic hydrocarbon resin, phthalate, benzoate, and the like.

The composition may include a reactive diluent. The reactive diluent may chemically react with the epoxy resin during cure. The reactive diluent may be an aliphatic, cycloaliphatic, or aromatic epoxy functional compound. The reactive diluent may be either monofunctional or multifunctional. according to embodiments, the reactive diluent comprises one or more of butyl-glycidyl ether, cresyl-glycidyl ether, 1,4 butanediol diglycidyl ether, 1,6 hexanediol diglycidyl ether, C12-C14 monoglycidyl ether, acrylic polymer, acrylic monomer, and the like.

The composition may further include up to approximately 5% by weight of at least one additive. Although referred to herein as an additive, the term additive may include an anti-foam agent and/or an air-release agent, defoamer, dispersing agent, surfactant, catalyst, and/or flow and leveling agent. According to some embodiments, the additive comprises a defoamer or another chemical selected to prevent foam formation, reduce or eliminate foam after it has formed, or remove air from a liquid or solution. In one embodiment, the defoamer suppresses foam formation during activities of the composition manufacture and application process that agitates the mixture in a manner that introduces air. additives may include, for example, silicone defoamer, non-silicone defoamer, unsaturated polyamine amides, acidic polyesters, polar acidic esters, unsaturated polycarboxylic acid, fatty acid ester, salicylic acid, p-toluenesulfonic acid, and the like.

The composition may further comprise a thixatrope to prevent settling of the constituents and to reduce sag during application of the coating composition. In one embodiment of the composition the thixatrope comprises bentonite clay, magnesium aluminum silicate, smectite clay, hectorite clay, methyl cellulose, ethyl cellulose, and the like.

The composition may further include a desired amount of one or more pigments up to approximately 10.0% by weight. In one embodiment, the pigment is selected from one or more of titanium dioxide, carbon black, red iron oxide, yellow iron oxide, phthalo blue/green, mixed metal pigment, aluminum, zinc, and other like pigments.

The composition may further include a desired amount of at least one extender up to approximately 50% by weight. In one embodiment the extender is selected from one or more of calcium meta-silicate, barium sulfate, mica (alumni potassium silicate), silica-alumina microspheres, magnesium silicate, calcium carbonate, alumina silicate, glass microspheres, hollow micro-spheres, nephelline syenite, micaceous iron oxide, silica, pyrophillite, zinc and the like.

The composition may further include a flash rust inhibitor up to 5% by weight. The flash rust inhibitor stops corrosion formation that may occur during the drying process of the zinc-rich waterborne epoxy coating applied to an iron, steel, or other ferrous metal. A flash rust inhibitor may include, for example, sodium nitrite, fatty acid amine complex, and other like flash rust inhibitors.

The composition may further include a conductive additive that further increases the conductivity of the cured film. According to embodiments, suitable conductive additives may include graphene, nano-graphene, carbon black pigment, zinc flake, carbon nanotubes, mica coated with antimony-doped tin oxide, conductive polymer powders, and the like.

The precise quantities and relative quantities of each of the constituents of the disclosed coating composition may vary according to the desired physical properties of the final coating composition.

TABLE 1

| | | |
|---|---|---|
| Ingredient | Minimum | Maximum |

COMPONENT 1

| | | |
|---|---|---|
| Amine Curing Agent | 5.00 | 80.00 |
| Thixatrope | 0.10 | 10.00 |
| Water | 5.00 | 75.00 |
| Additives | 0 | 5.00 |
| Pigment | 0 | 10.00 |
| Extender | 0 | 50.00 |
| Flash Rust Inhibitor | 0 | 5.00 |

COMPONENT 2

| | | |
|---|---|---|
| Epoxy Resin | 0 | 100.00 |
| Diluent | 0 | 100.00 |

COMPONENT 3

| | | |
|---|---|---|
| Zinc Dust | 40.00 | 100.00 |
| Micaceous Iron Oxide | 0 | 60.00 |

TABLE 1 comprises ranges of weight percentages for the various constituents of a coating composition, in accordance with a first embodiment. For each range disclosed, it is contemplated that each point within the disclosed range is a viable percent weight for the constituent associated with that range, and that the disclosure of the ranges in TABLE 1 constitutes disclosure of the individual points falling within the ranges.

As disclosed above, a zinc-rich waterborne epoxy coating composition may be prepared by the mixture of three pre-blended components. A first component includes a waterborne amine curing agent. A second component includes an epoxy resin. A third component includes zinc dust. The first component may also include one or more of a thixatrope, water, a defoamer, a pigment, an extender, and a flash rust inhibitor. The second component may also include a diluent. The third component may also include micaceous iron oxide. When combined, the first, second, and third components produce a zinc-rich waterborne epoxy coating that is applied to the surface of a metal substrate to protect the metal substrate from corrosion.

Exemplary embodiments of the waterborne epoxy coating composition are divided into three parts, one aqueous, non-aqueous, and dry, for easy storage and transportation. The aqueous part may be referred to herein as “Component 1,” and includes between 5% to 80% by weight curing agent, between 5% to 50% by weight curing agent, or between 15% and 35% curing agent, in a total amount sufficient to react with epoxy resin included in the non-aqueous part, and desired amounts of other additives as described above and in the examples below. The non-aqueous part may be referred to herein as “Component 2,” and includes between 0% to 100% by weight epoxy resin, between 50% to 100% by weight epoxy resin, or between 80% to 100% epoxy resin; and desired amounts of other additives as described above and in the examples below. The dry part is may be referred to herein as “Component 3,” and includes between 40% to 100% by weight zinc dust, between 60% to 100% by weight zinc dust, or between 80% to 100% zinc dust; and desired amounts of other additives as described above and in the examples below.

Although the zinc-rich waterborne epoxy coating is shown and described as a three-component composition, the constituents of Component 3 and/or the zinc may be mixed into Component 1, Component 2, or a combination of Component 1 and Component 2, according to particular needs. Although a two component composition would be more easily transported, a three component composition gives better flexibility to adjust the amount of zinc present in the composition. As described in further detail below, the amount of zinc added to the composition may be adjusted depending on the particular environment of the metal substrate that is being coated. Using a three component system provides for the ability to easily increase the amount of zinc in the final product to provide anti-corrosion protection in more corrosive environments as well as easily decrease the amount of zinc in the final product to reduce costs of the coating in less corrosive environments.

Another embodiment comprises combining the three parts by adding Component 1 to Component 2 in any suitable container with mechanical agitation to substantially uniformly mix the two parts together, wherein the final composition has a stoichiometric ratio of total epoxy groups to equivalent of reactive curing agent amine groups of approximately 0.8:1 to approximately 1.5:1; a ratio of approximately 0.95:1 to 1.25, or a ratio of approximately 1.05:1 to 1.15:1. Component 3 may be added after Component 1 and Component 2 are mixed. The substantially uniformly mixed composition is then applied to the surface to be coated appropriate epoxy coating application equipment. The weight ratios of Component 1 and Component 2 are determined by the stoichiometric ratio, disclosed above. When working with a three component formula the amount of Component 3 to be used is determined by the zinc load desired in the coating.

An embodiment of the waterborne epoxy coating composition comprises an aqueous Component 1 that includes a waterborne amine curing agent, a thixatrope, a defoamer, a pigment, an extender, and a flash rust inhibitor; a non-aqueous Component 2 that includes an epoxy resin and a reactive diluent; and a solid Component 3 that includes zinc particles and micaceous iron oxide. The three components may be mixed by combining Component 1, Component 2, and Component 3 in a suitable container with mechanical agitation to substantially uniformly mix the three parts together. The substantially uniformly mixed composition may then be applied as a coating to a metal substrate using epoxy coating application equipment, such as, for example, a brush, roller, or airless sprayer. In one embodiment, the composition is applied as a coating with a dry film thickness of between approximately 0.5 mils to 5.0 mils, in one coat. Although embodiments are described as applying the coating composition with a dry film thickness of approximately 0.5 mils to 5.0 mils in one coat, embodiments contemplate other thicknesses applied in more than one coat, according to particular needs.

Although the zinc-rich waterborne epoxy coating composition is described above as comprising a particular range of weight percentage for each of the constituents of each component, embodiments contemplate addition of one or more constituents other than those provided in TABLE 1, as well as other ranges of weight percentage for each of the constituents, according to particular needs. It is further contemplated that one of skill in the art will be able to readily ascertain the appropriate amount of the constituent to use based on TABLE 1, above, as well as the further examples provided below.

TABLE 2

| | | |
|---|---|---|
| Ingredient | Minimum | Maximum |

COMPONENT 1

| | | |
|---|---|---|
| Amine Curing Agent | 5.00 | 50.00 |
| Thixatrope | 0.10 | 7.50 |
| Water | 10.00 | 60.00 |
| Additive | 0 | 2.50 |
| Pigment | 0.10 | 5.00 |
| Extender | 5.00 | 40.00 |
| Flash Rust Inhibitor | 0.01 | 3.00 |

COMPONENT 2

| | | |
|---|---|---|
| Epoxy Resin | 50.00 | 100.00 |
| Diluent | 0 | 50.00 |

COMPONENT 3

| | | |
|---|---|---|
| Zinc Dust | 60.00 | 100.00 |
| Micaceous Iron Oxide | 0 | 40.00 |

TABLE 2 comprises ranges of weight percentages for the various constituents of a coating composition, in accordance with a second embodiment. The values provided in TABLE 2 may comprise an alternate embodiment to those provided in TABLE 1.

TABLE 3

| | | |
|---|---|---|
| Ingredient | Minimum | Maximum |

COMPONENT 1

| | | |
|---|---|---|
| Amine Curing Agent | 15.00 | 35.00 |
| Thixatrope | 0.50 | 3.00 |
| Water | 25.00 | 55.00 |
| Additive | 0.10 | 1.00 |
| Pigment | 0.5 | 3.00 |
| Extender | 15.00 | 30.00 |
| Flash Rust Inhibitor | 0.01 | 1.50 |

COMPONENT 2

| | | |
|---|---|---|
| Epoxy Resin | 80.00 | 100 |
| Diluent | 0 | 20.00 |

COMPONENT 3

| | | |
|---|---|---|
| Zinc Dust | 80.00 | 100.00 |
| Micaceous Iron Oxide | 0 | 20.00 |

TABLE 3 comprises ranges of weight percentages for the various constituents of a coating composition, in accordance with a third embodiment. For each of the ranges disclosed in TABLES 1-3, the ranges are meant to include every individual point falling within the disclosed range.

By way of example only and not by way of limitation, one or more examples are provided below as illustrations only, as numerous modifications and variations within the scope of the present disclosure would be apparent to one having skill in the art. Unless otherwise noted, all parts, percentages, and ratios reported in the following examples are on a weight basis.

TABLE 4

| | |
|---|---|
| Ingredient | Weight Percent |

COMPONENT 1

| | |
|---|---|
| Amine Curing Agent | 25.00 |
| Thixatrope | 1.50 |
| Water | 44.70 |
| Additives | 0.78 |
| Pigment | 3.00 |
| Extender | 25.00 |
| Flash Rust Inhibitor | 0.02 |

COMPONENT 2

| | |
|---|---|
| Epoxy Resin | 82.00 |
| Diluent | 18.00 |

COMPONENT 3

| | |
|---|---|
| Zinc Dust | 95.00 |
| Micaceous Iron Oxide | 5.00 |

TABLE 4 comprises weight percentages for the various constituents of a coating composition, in accordance with a fourth embodiment. In one embodiment, the composition of TABLE 4 is prepared by mixing 1.5 gallons of Component 1, 0.5 gallons of Component 2, and a variable amount of Component 3 to provide the desired level of corrosion resistance, as shown in greater detail below. As discussed above, traditional zinc rich coatings use very high levels of zinc particles to achieve the necessary interaction of the particles to provide the proper level of protection. For the zinc-rich waterborne epoxy coating of the current disclosure, the micro-porosity of the polymer structure improves the interaction among the zinc particles in the cured film, which increases their conductivity as well as their ability to provide cathodic protection and anti-corrosion protection to a metal substrate. By increasing the contact between zinc particles, the zinc-rich waterborne epoxy coating composition requires a lower level of zinc to provide the same cathodic protection compared with an equivalent solvent-based organic zinc-rich coating.

Experimental Results

The experiments below illustrate the corrosion resistance and the galvanic action of the zinc-rich waterborne epoxy coating composition.

TABLE 5

| | Conductivity |
|---|---|
| Product | (mV) |
| Zinc-Rich Waterborne Epoxy Coating | −984 |
| Zinc-Rich Solvent-Based Epoxy Coating | −878 |
| Zinc-Rich Solvent-Based Moisture Cure | −874 |
| Urethane Coating | |
| Zinc-Rich Solvent-Based Inorganic Coating | −945 |

TABLE 5 comprises conductivity of various dry-film epoxy compositions, according to an embodiment. Here, the galvanic action of the zinc-rich waterborne epoxy coating is compared with solvent-based coatings. Solvent-based organic zinc-rich coatings may be formulated with polyurethane, epoxy, phenoxy, phenolic, and other like resin systems. The use of ceramic microspheres combined with a conductive additive, such as, for example, carbon black, graphene, carbon nanotubes, tin antimony oxide, a conductive resin (such as, for example, polyaniline) may be used to lower the zinc load level to maintain proper cathodic protection. However, the formation of a micro-porous network in the disclosed zinc-rich waterborne epoxy coating compares favorably from a galvanic action, which correlates with the corrosion resistance of the coating.

The corrosion resistance of the zinc-rich waterborne epoxy coating composition was further tested using a salt fog test (ASTM B117), a cyclic salt fog/UV test (ASTM D5894), and a controlled condensation test (ASTM D4585). Results are presented as scribe ratings (ASTM D1654), blister ratings (ASTM D714), and rust ratings (ASTM D610).

TABLE 6

| Percent Zinc | Salt Fog Exposure (Blister/Rust Rating) | | | | |
|---|---|---|---|---|---|
| in Dry Film | 500 | 750 | 1250 | 1500 | 2000 |
| (w/w %) | hours | hours | hours | hours | hours |
| 55 | 9F/10 | 8D/10 | 8D/6 | Not Rated | Not Rated |
| 65 | 8/9 | 8/9 | 8D/7 | Not Rated | Not Rated |
| 75 | 10/10 | 10/10 | 10/10 | 10/10 | 10/10 |
| 82 | 10/10 | 10/10 | 10/10 | 10/10 | 10/10 |

TABLE 6 illustrates the corrosion resistance of the zinc-rich waterborne epoxy coating composition according to the salt fog test with various weight percentages of zinc for a various number of hours, according to an embodiment. For this test, a sample of steel was coated with the zinc-rich waterborne epoxy coating composition (as disclosed in TABLE 4), placed in a controlled corrosive environment for between 500 and 2000 hours, and subsequently scored for its blister rating and rust rating. As disclosed above, loading level of zinc in the zinc-rich waterborne epoxy composition may be adjusted by increasing or decreasing the amount of Component 3, with respect to the dry film weight of the composition of Components 1 and 2. For example, a 55% weight of zinc in dry film is prepared by mixing 1.5 gallons of Component 1 with 0.5 gallons of Component 2 and 19.25 lbs. of Component 3 using the composition disclosed above in TABLE 4. Embodiments contemplate additional compositions prepared at different percentage weights of zinc in dry film by mixing the following weights of zinc with 1.5 gallons of Component 1 and 0.5 gallons of Component 2: 65%-30.5 lbs.; 75%-53.4 lbs., and 82%-93.7 lbs. The salt fog test was run on steel coated with the zinc-rich waterborne epoxy coating composition having various loading levels of zinc and a coating thickness of 2.5-3.5 mils dry film thickness (dft). The results indicate that corrosion protection equivalent to a zinc-rich organic coating are achieved by the zinc-rich waterborne epoxy coating composition with much a lower zinc content. For example, a typical zinc-rich organic coating uses a zinc loading level range from 82% to 89% by weight in the dry film, but often provides sufficient corrosion protection at the higher end of the range (i.e. 88% to 89%) zinc by weight of the dry film. As seen above, zinc-rich waterborne epoxy coating composition may achieve similar corrosion resistance with zinc levels as low as 55 w/w %. However, long-term protection (at a 10/10 (blister rating/rust rating)) is provided with for as long as 2000 hours with a zinc-loading level of 75%. Other embodiments contemplate providing the anti-corrosion protection for ferrous metals with a coating of the zinc-rich waterborne epoxy composition having a zinc loading level of greater than 65%, between 65% and 75%, more than 75%, between 75% and 82%, at 82%, or greater than 82%, according to particular needs.

TABLE 7

| Scribe Rating | Blister Rating | Rust Rating |
|---|---|---|
| 10 | 10 | 10 |

TABLE 7 illustrates the corrosion resistance of the zinc-rich waterborne epoxy coating composition according to the salt fog test with an exposure of 3500 hours. For this test, a sample of steel was coated with the zinc-rich waterborne epoxy coating composition (comprising the formulation of TABLE 4 and mixed in the following ratio: 1.5 gallons of Component 1 with 0.5 gallons of Component 2 and 57.4 lbs. of Component 3) placed in a controlled corrosive environment for 3500 hours, and subsequently scored for its scribe rating, blister rating, and rust rating. The testing was run in triplicate with a coating thickness of 2.5 to 3.5 mils dft.

TABLE 8

| Blister Rating | Rust Rating |
|---|---|
| 10 | 10 |

TABLE 8 illustrates the corrosion resistance of the zinc-rich waterborne epoxy coating composition according to the cyclic salt fog/UV test with an exposure of 1680 hours. The cyclic salt fog/UV test more closely mirrors the conditions of painted metals in real-world outdoor applications. Instead of providing a static set of corrosive conditions, this test provides a more realistic simulation of the compounding effects of changing environmental conditions, such as, for example, corrosive atmospheres, rain, condensed dew, UV light, wet/dry cycling, and temperature cycling. The testing was run in triplicate with a coating thickness of 2.7 to 3.9 mils dft, using a coating composition comprising the formulation of TABLE 4 and mixed in the following ratio: 1.5 gallons of Component 1 with 0.5 gallons of Component 2 and 57.4 lbs. of Component 3.

TABLE 9

| Blister Rating | Rust Rating |
|---|---|
| 10 | 10 |

TABLE 9 illustrates the corrosion resistance of the zinc-rich waterborne epoxy coating composition according to the controlled condensation test with an exposure of 2000 hours. As disclosed above, water is a significant factor in the corrosion of metal-substrates. This test scored a metal-substrate coated with the zinc-rich waterborne epoxy coating composition (comprising the formulation of TABLE 4 and mixed in the following ratio: 1.5 gallons of Component 1 with 0.5 gallons of Component 2 and 57.4 lbs. of Component 3) for water-related failure after exposure for a selected time period to water condensation in a test chamber. Particular failures that may be identified include a deficiency in the coating composition, contamination of the substrate, or inadequate surface preparation. The testing was run in triplicate with a coating thickness of 3.5 to 5.0 mils dft.

Thus, a zinc-rich waterborne epoxy composition is disclosed which utilizes zinc particles and a waterborne amine curing agent to provide protection to a metal substrate against corrosion and other environmental threats. The coating composition provides corrosion resistance equal to organic solvent based and solvent free epoxy coatings.

While the exemplary embodiments have been shown and described, it will be understood that various changes and modifications to the foregoing embodiments may become apparent to those skilled in the art without departing from the spirit and scope of the present invention. Reference in the foregoing specification to “one embodiment”, “an embodiment”, or “another embodiment” means that a particular feature, structure, or characteristic described in connection with the embodiment is included in at least one embodiment of the invention. The appearances of the phrase “in one embodiment” in various places in the specification are not necessarily all referring to the same embodiment.

1. A composition for use in coating surfaces, the composition comprising:
(a) a first component including:
(i) 15% to 35% by weight of a waterborne amine curing agent;
(b) a second component including:
(i) 80% to 100% by weight of an epoxy resin; and
(c) a third component including:
(i) 80% to 100% by weight of zinc dust; and
(d) the first component, the second component, and the third component being combinable to provide a zinc-rich waterborne epoxy coating, wherein the coating composition provides an anti-corrosion protection to a metal substrate.

2. The composition according to claim 1, wherein the waterborne amine curing agent forms a micro-porous polymer structure in the cured film.

3. The composition according to claim 1, wherein the waterborne amine curing agent is selected from a waterborne amine curing agent that provides moisture permeability to an epoxy coating when applied to a concrete surface.

4. A process for providing anti-corrosion protection to a metal substrate, the process comprising:
(a) preparing a zinc-rich waterborne epoxy coating composition, the coating composition comprising:
(i) at least one epoxy resin;
(ii) at least one waterborne amine curing agent; and
(iii) zinc dust;
(b) applying the coating composition to a surface of a metal substrate; and
(c) permitting the coating composition to cure to form a porous protective coating providing cathodic protection to the metal substrate.

5. The composition according to claim 4, wherein the at least one waterborne amine curing agent forms a micro-porous polymer structure in the cured film.

6. The composition according to claim 4, wherein the at least one waterborne amine curing agent is selected from a waterborne amine curing agent that provides moisture permeability to an epoxy coating when applied to a concrete surface.

7. The process of claim 4, wherein preparing a zinc-rich waterborne epoxy coating composition further comprises:
combining a first component comprising the at least one waterborne amine curing agent with a second component comprising the at least one epoxy resin;
adding a third component comprising the zinc dust to the first component and the second component; and
mechanically agitating the combined first, second, and third components to obtain a substantially uniform mixture.

8. The process of claim 7, wherein the uniform mixture comprises a stoichiometric ratio of total epoxy groups to equivalent of reactive curing agent amine groups of approximately 1.05:1 to 1.15:1.

9. The composition of claim 1, wherein the waterborne amine curing agent is selected from one or more of a cycloaliphatic amine, aromatic amine, polyether amine, polyamide, aminoamide, adduct or Mannich-based terminated amine, tertiary amine.

10. The composition of claim 1, wherein the first component further comprises one or more of non-reactive diluent, thixatrope, defoamer, pigment, extender, and flash rust inhibitor.

11. The composition of claim 10, wherein the extender is selected from one or more of calcium meta-silicate, barium sulfate, mica (alumina potassium silicate), silica-alumina microspheres, magnesium silicate, calcium carbonate, alumina silicate, glass microspheres, hollow micro-spheres, nephelline syenite, micaceous iron oxide, silica, and pyrophillite.

12. The composition of claim 1, wherein the epoxy resin is selected from one or more of bisphenol A, bisphenol F, epoxy phenol Novolac, and epoxy cresol.

13. The composition of claim 1, wherein the second component comprises a reactive diluent selected from one or more of butyl-glycidyl ether, cresyl-glycidyl ether, 1,4-butanediol diglycidyl ether, 1,6-hexanediol-diglycidyl ether, C12-C14 monoglycidyl ether, acrylic polymer, and acrylic monomer.

14. The composition of claim 1, wherein the third component further comprises one or more of micaceous iron, graphene, nano-graphene, carbon black pigment, zinc flake, carbon nanotubes, mica coated with antimony-doped tin oxide, and conductive polymer powder.

15. The composition of claim 1, wherein the third component comprises up to approximately 20% by weight of micaceous iron oxide.

16. The process of claim 7, wherein the first component comprises 15% to 35% by weight of the at least one waterborne amine curing agent.

17. The process of claim 7, wherein the second component comprises 80% to 100% by weight of the at least one epoxy resin.

18. The process of claim 7, wherein the third component comprises 80% to 100% of the zinc dust.

19. The process of claim 7, wherein the waterborne amine curing agent is selected from one or more of the following: cycloaliphatic amine, aromatic amine, polyether amine, polyamide, aminoamide, adduct or Mannich-based terminated amine, and tertiary amine.

20. The process of claim 7, wherein the epoxy resin is selected from one or more of bisphenol A, bisphenol F, epoxy phenol Novolac, and epoxy cresol.

21. The process of claim 7, wherein the third component further comprises one or more of micaceous iron, graphene, nano-graphene, carbon black pigment, zinc flake, carbon nanotubes, mica coated with antimony-doped tin oxide, and conductive polymer powder.
